(19) United States
(12) Patent Application Publication
(10) Pub. No.: US 2025/0202542 A1
(43) Pub. Date: Jun. 19, 2025

(54) METHODS AND DEVICES TO SELECT A MULTIPLE INPUT MULTIPLE OUTPUT (MIMO) DETECTION ALGORITHM

(71) Applicant: Intel Corporation, Santa Clara, CA (US)

(72) Inventors: Niranjan MYLARAPPA GOWDA, Hillsboro, OR (US); Andrey BELOGOLOVY, Hillsboro, OR (US); Maryam ESLAMI RASEKH, San Jose, CA (US); Evgeny STUPACHENKO, San Jose, CA (US)

(21) Appl. No.: 18/544,502

(22) Filed: Dec. 19, 2023

(51) Int. Cl. H04B 7/0413; H04L 25/02

(52) U.S. Cl. CPC H04B 7/0413; H04L 25/0256

(57) ABSTRACT

An apparatus may include a processor configured to: determine a class for a condition number of a channel matrix from a plurality of classes; wherein the channel matrix is representative of a communication channel; determine an off-diagonal dominance of a gram matrix or a spatial covariance matrix associated with the communication channel; and select a multiple input multiple output (MIMO) detection method from a plurality of MIMO detection methods based on the determined class and an off-diagonal dominance.

### TECHNICAL FIELD

This disclosure generally relates to methods and devices to select a MIMO detection algorithm.

### BACKGROUND

In radio communication networks in accordance with many radio communication technologies, such as Fourth Generation (LTE) and Fifth Generation (5G) New Radio (NR), various methods are employed to provide wireless data transfer with desired efficiency, speed, and reliability. One of these methods involves MIMO (Multiple Input Multiple Output) communication which is a wireless technology that leverages multiple antennas at both transmitter and receiver entities to enhance data transfer efficiency, capacity, and reliability. By using spatial diversity, MIMO systems may allow simultaneous transmission of multiple data streams over the same frequency band, which may result in an increase of data throughput per communication resource. MIMO communication may include techniques like beamforming and spatial multiplexing to take advantage of the diverse propagation paths in the radio environment to improve signal quality, and to mitigate fading effects and interference.

One aspect of MIMO communication is MIMO detection which may involve the estimation of transmitted symbols or data streams at the receiver in accordance with complex interactions between multiple transmitted signals and their reflections (i.e. interference) across various channels. There are various MIMO detection algorithms that may include linear methods like Zero Forcing (ZF) and Minimum Mean Square Error (MMSE) that are less complex than more intricate iterative techniques such as Successive Interference Cancellation (SIC) and Maximum Likelihood (ML). In general, a MIMO detection algorithm may aim to recover the transmitted information accurately while combating interference and accounting for channel characteristics like fading and noise. These algorithms may also optimize signal recovery by exploiting spatial diversity, adjusting reception strategies, and enhancing the decoding process for a more reliable and high-throughput data transmission in MIMO-enabled wireless communication systems.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an exemplary illustration of a MIMO communication system;

FIG. 4 shows an example of an apparatus according to various examples in this disclosure;

FIG. 5 shows an exemplary illustration of a graph of a condition number and an off-diagonal dominance of a Gram matrix (or a Channel matrix);

FIG. 6 shows an example of a processor and a memory of a device according to various aspects provided in this disclosure;

FIG. 7A shows an exemplary illustration of a graph showing Gershgorin discs of a diagonally dominant matrix along with the eigenvalues of the same matrix;

FIG. 7B shows an exemplary illustration of a graph showing Gershgorin discs of an arbitrary random channel matrix along with the eigenvalues of the same matrix;

FIG. 8 shows an illustration of a flow diagram to determine a class of a condition number of a Gram matrix (or channel matrix)

FIG. 9 shows an exemplary illustration of a method.

### DESCRIPTION

The following detailed description refers to the accompanying drawings that show, by way of illustration, exemplary details and aspects in which aspects of the present disclosure may be practiced.

Channel estimation is crucial for both radio communication devices, access nodes such as base stations (BS), and mobile radio communication devices (e.g. terminal devices, such as UEs). For access nodes and terminal devices, accurate channel estimation is essential for MIMO communication. Channel information may help terminal devices decode signals effectively, allocate power efficiently, and utilize advanced techniques like spatial multiplexing. Accordingly, an accurate channel estimation may benefit both access nodes and terminal devices within a radio access network, facilitating reliable and efficient communication across the wireless network.

Conventionally, a MIMO detection algorithm may identify the relationship between transmitted and received signals in a system including a transmitter transmitting signals and a receiver receiving signals with multiple antennas. When the transmitter sends out transmitted signals (i.e. transmit signals), the transmit signals pass through a communication channel, getting changed along the way due to various features associated with the communication channel, such as propagation loss, interfering signals, etc. Accordingly, the receiver receives these changed signals (i.e. receive signals) which carry the original information but also have noise and channel effects mixed in with the original information.

Accordingly, a receiver may implement a MIMO detection algorithm in order to isolate the noise and channel effects from the original information transmitted by the transmitter (e.g. transmit signal) to recover the original transmit signals. Receivers may employ various MIMO detection algorithms, which may designated in accordance with various needs and features, such as the quality of the communication channel (i.e. expected noise, channel effects), desired error rate, number of antennas used for MIMO communication, processing capabilities of the receiver, desired processing delay, etc.

Some MIMO detection algorithms, like Zero Forcing (ZF) and Minimum Mean Square Error (MMSE), may have a lower processing complexity, which may be configured to handle interference and noise to estimate transmit signals by using information representing characteristics of the communication channel, such as channel estimates. These algorithms may estimate transmit signals with less processing overhead, but they may also be prone to errors, particularly depending on the quality of the communication channel.

Some MIMO detection algorithms, like Successive Interference Cancellation (SIC) and Maximum Likelihood (ML), may have a higher processing complexity compared to the ZF or the MMSE. They may be configured to use more complex calculations with the receive signals to determine transmit signals. Some of such MIMO detection algorithms having higher processing complexity may adjust how the respective MIMO detection algorithm determine transmit signals based on the conditions of the communication channel for the purpose of more accurate determination of transmit signals when compared to less complex MIMO detection algorithms.

Traditionally, a receiver implements a single MIMO detection algorithm that is designated in accordance with the needs and features previously identified with respect to desired radio communication performance and the complexity of the MIMO detection algorithm suitable for the conditions of the receiver and the radio communication channel.

Illustratively, a receiver may generally communicate with communication channels generally having a good quality (e.g. no/less interfering signals, less propagation loss, etc. in comparison with a communication channel having a bad quality) and accordingly, it may implement a MIMO detection algorithm with a lower processing complexity, as the receiver may obtain a desired accuracy of determining transmit signals with such MIMO detection algorithms. On the other hand, a receiver may communicate with communication channels having a bad quality (more interfering signals, more propagation loss, etc. in comparison with a communication channel having a good quality), at least from time to time, and accordingly, it may implement a MIMO detection algorithm with a higher processing complexity, as the receiver may not obtain a desired accuracy of determining transmit signals with MIMO detection algorithms having lower processing complexity.

Noting that the receiver may encounter different and/or unpredictable channel conditions, not a single designated MIMO detection algorithm may be suitable for the receiver to obtain the desired accuracy for determination of transmit signals with the single MIMO detection algorithm. In accordance with various aspects provided, a receiver may be configurable to implement a plurality of MIMO detection algorithms and select a MIMO detection algorithm among the plurality of applicable MIMO detection algorithms based on designated states.

For example, the receiver may select a MIMO detection algorithm having more complexity when, for example, a particular accuracy is desired or when channel conditions are bad, or when symbol error rate is over a designated threshold. Similarly, the receiver may select a MIMO detection algorithm having less complexity when, for example, the quality of the communication channel is estimated over a designated threshold, or when a prompt determination of transmit signals is desired, or when a lower power consumption is desired, or when less processor overhead is desired.

In some aspects, in particular in a disaggregated network architecture such as Open Radio Access Network (O-RAN), the receiver that determines the transmit symbols may not be necessarily the entity of the network that receives radio communication channels (e.g. O-RU), but the receiver may be an entity (e.g. O-DU) of the network, the entity which is connected to one or multiple entities of the network, which receive radio communication channels. The receiver, as designated here, may implement MIMO detection algorithms based on receive signals obtained by external entities, hence a flexibility among different conditions or among different radio communication signal receiving entities. An optimal MIMO detection algorithm for a radio communication signal receiving entity may be different from another radio communication signal receiving entity, in case a receiver that is common for the radio communication signal receiving entity performs the MIMO detection.

In accordance with various aspects provided herein, a receiver may be expected to be capable to select a MIMO detection algorithm from a plurality of MIMO detection algorithms in a practical manner, in particular, without introducing too much delay or processing overhead for the implementation of the MIMO detection algorithm. In theory, a processor of the receiver may select a MIMO detection algorithm from a plurality of MIMO detection algorithms based on current conditions of the communication channel to obtain a desired accuracy for determination of transmit signals, however estimating whether the channel conditions are more suitable for a less complex MIMO detection algorithm, or whether the channel conditions are more suitable for a more complex MIMO detection algorithm, may be cumbersome, and may require a considerable amount of processing overhead and processing delay.

In some aspects, a channel matrix may represent conditions of a MIMO communication channel. The receiver may use various known methods and techniques to estimate and/or obtain the channel matrix. In some aspects, the channel matrix may indicate whether conditions of the communication channel is suitable for a more complex MIMO detection algorithm or suitable for a less complex MIMO detection algorithm by its condition number. The condition number is a mathematical metric to assess the quality of the channel matrix. The condition number of a matrix is a measure of how well-conditioned or ill-conditioned the matrix is, and accordingly it may provide an insight into the stability and accuracy of numerical computations involving that matrix. Mathematically, a condition number (K) of a matrix (A) may be calculated as the following, ∥ ∥ denoting matrix norm of the respective matrix:

$$κ ( A ) = ‖ A ‖ ‖ {A}^{- 1} ‖$$

In some aspects, the sole condition number of the channel matrix may not be sufficient for the purpose of indicating whether MIMO detection to be performed is suitable for a selection of a less complex MIMO detection algorithm, or whether MIMO detection to be performed is suitable for a selection of a more complex MIMO detection algorithm. Accordingly, the processor of the receiver may use, in addition to the calculated condition number, corresponding spatial covariance matrix and/or the Gram matrix associated with the MIMO communication for this determination. It is however to be noted that, for a M×N MIMO communication, in which M is the number of receive antennas and N is the number of transmit layers, the processor may perform an O(N²) operation in case a spatial covariance matrix and/or Gram matrix is already available for another purpose, but the processor may require to perform an O(N³) operation to calculate the condition number. In fact, the complexity of condition number computation is nearly or sometimes even greater than some MIMO detection algorithms themselves.

Illustratively, after a channel estimation stage, a processor may compute the off-diagonal dominance, as described herein, by performing O(N²) operations. However, the known methods for condition number estimation may require performing O(N³). This is because computing condition number may require computing extremal eigen values, which is an O(N³) operation. So, the condition number computation can be nearly as complex and sometimes even more complex than the MMSE detection itself.

In accordance with various aspects provided herein, the processor of the receiver may not necessarily calculate the condition number by performing an O(N³) operation, but estimate a coarse value for the condition number based on the channel matrix. Illustratively, the processor may determine a class (e.g. a class of magnitude) for the condition number of the channel matrix from a plurality of classes (e.g. classes of magnitude). The determined class of magnitude may be indicative of whether the condition number is above a designated number, or below a designated number, or between two designated numbers. Accordingly, the processor may select the MIMO detection algorithm by performing, at most, O(N²) operations.

In accordance with various aspects provided herein, the processor may predict a bit error rate gap between a first bit error rate (BER) estimated for a first MIMO detection algorithm with a first complexity and a second BER estimated for a second MIMO detection algorithm with a second complexity. Illustratively, the first MIMO detection algorithm may include MMSE and the second MIMO detection algorithm may include ML. Based on the predicted BER gap, the processor may determine whether to use the first MIMO detection algorithm (e.g. BER gap is below a threshold) or the second MIMO detection algorithm (e.g. BER gap is above a threshold), or a third MIMO detection algorithm having a different computation complexity than the first MIMO detection algorithm and the second MIMO detection algorithm. In some aspects, the processor may use the class of magnitude determined for the condition number of the channel matrix, and optionally a calculated diagonal dominance (e.g. off-diagonal dominance) of the spatial covariance matrix or the Gram matrix to predict the BER gap.

In some aspects, the processor may use a trained machine learning (ML) model, such as a trained neural network (NN), to determine the class of magnitude of the condition number of the channel matrix. In particular, the receiver may include a neural network-based classifier for classification of the condition number of the channel matrix into a class of multiple classes. In some aspects, the trained ML model may receive input data representative of Gershgorin discs of the Gram matrix obtained from the channel matrix and estimate a coarse condition number based on the received input data. The NN-based classifier may accordingly select a class for the condition number of the channel matrix based on the coarse condition number. Accordingly, the NN-based classifier may provide a low complexity operation that is accurate enough to classify the actual condition number of the channel matrix. Furthermore, use of the off-diagonal dominance of the spatial covariance matrix and/or the Gram matrix may provide further indication to the processor for an optimal selection of the MIMO detection algorithm.

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 4G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mm Wave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 690-960 MHZ, 1710-2025 MHZ, 2110-2200 MHZ, 2300-2400 MHZ, 2500-2690 MHz, 698-790 MHz, 610-790 MHZ, 3400-3600 MHZ, etc., where some bands may be limited to specific region(s) and/or countries), IMT-advanced spectrum, IMT-2020 spectrum (expected to include 3600-3800 MHZ, 3.5 GHz bands, 600 MHz bands, bands within the 24.25-86 GHz range, etc.), spectrum made available under FCC's “Spectrum Frontier” 4G initiative (including 27.5-28.35 GHz, 29.1-29.25 GHz, 31-31.3 GHz, 37-38.6 GHz, 38.6-40 GHz, 42-42.5 GHz, 47-64 GHz, 64-71 GHz, 61-76 GHz, 81-86 GHz and 92-94 GHz, etc.), the ITS (Intelligent Transport Systems) band of 4.9 GHz (typically 4.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 60.2 GHz-71 GHz band, any band between 65.88 GHz and 61 GHz, bands currently allocated to automotive radar applications such as 66-81 GHz, and future bands including 94-300 GHz and above. Furthermore, the apparatuses and methods described herein can also employ radio communication technologies on a secondary basis on bands such as the TV White Space bands (typically below 690 MHZ) where e.g. the 400 MHz and 600 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

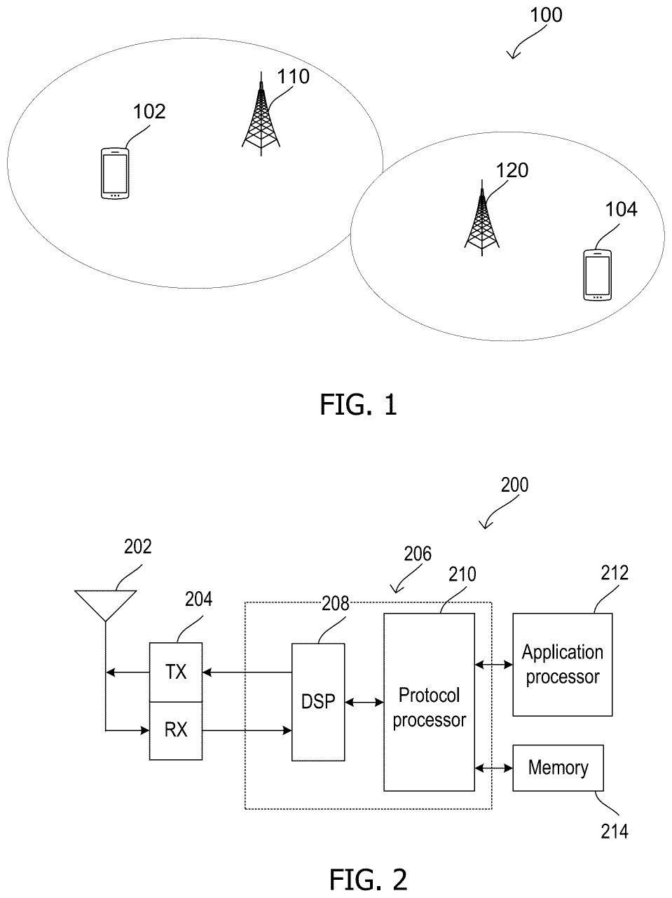

FIGS. 1 and 2 depict a general network and device architecture for wireless communications. In particular, FIG. 1 shows exemplary radio communication network 100 according to some aspects, which may include terminal devices 102 and 104 and network access nodes 110 and 120. Radio communication network 100 may communicate with terminal devices 102 and 104 (i.e. mobile radio communication devices) via network access nodes 110 and 120 (i.e. radio communication devices) over a radio access network. Although certain examples described herein may refer to a particular radio access network context (e.g., LTE, UMTS, GSM, other 3rd Generation Partnership Project (3GPP) networks, WLAN/WiFi, Bluetooth, 4G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mm Wave, etc., any of which may be applicable to radio communication network 100. In accordance with aspects described herein, a network access node 110, 120 or a terminal device 102, 104 may implement aspects described herein (e.g. selection of MIMO detection algorithms, determination of a class for a condition number of a channel matrix, and/or determination a diagonal dominance of a gram matrix and/or spatial covariance matrix).

FIG. 2 shows an exemplary internal configuration of a communication device according to various aspects provided in this disclosure. The communication device may include various aspects of radio communication devices (e.g. network access nodes 110, 120) or various aspects of mobile radio communication devices (e.g. terminal device 102, 104) as well. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAS), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with various aspects provided herein, at least one of baseband modem 206 or application processor 212 may perform processing to provide aspects disclosed herein. For example, at least one of baseband modem 206 or application processor 212 may implement aspects described herein (e.g. selection of MIMO detection algorithms, determination of a class for a condition number of a channel matrix, and/or determination a diagonal dominance of a gram matrix and/or spatial covariance matrix).

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

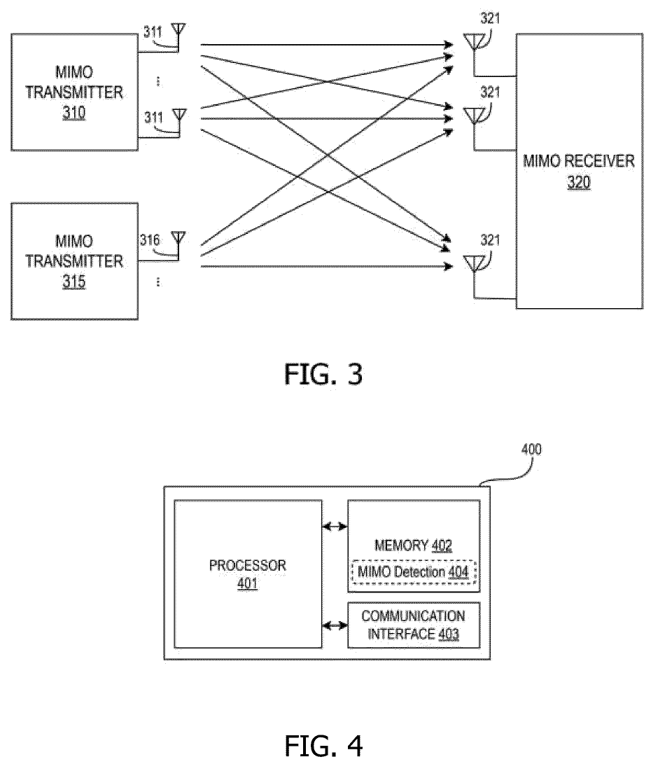

FIG. 3 shows an exemplary illustration of a MIMO communication system including a first transmitter (i.e. MIMO transmitter) 310, a second transmitter (i.e. MIMO transmitter) 315, and a receiver (i.e. MIMO receiver) 320. It is however to be noted that various aspects described herein may include various MIMO communication methods, such as i) a multi-user MIMO (MU-MIMO) in which the receiver 320, which may illustratively be a base station including a large number of antennas (example, 64 or 128 antennas) and possibly multiple transmitters (e.g. the first transmitter 310 and the second transmitter 315, e.g. 2 to 8 UEs) each having one or more antennas (e.g. 1-4 antennas each); or ii) a single user MIMO (SU-MIMO) which may include a single transmitter (e.g. the first transmitter 310) and a single receiver (e.g. the receiver 320).

Illustratively, the first transmitter 310, the second transmitter 315 and the receiver 310 each may include a respective communication device as described in accordance with FIG. 2 configured for MIMO communication. The first transmitter 310 may include a plurality of antennas 311 to transmit radio communication signals. The second transmitter 315 may include one or more antennas 316 to transmit radio communication signals. A MIMO receiver 320 may include a plurality of antennas 321 to receive radio communication signals.

In a MU-MIMO operation, the first transmitter 310 and the second transmitter may transmit substantially simultaneously. The first transmitter 310 may transmit multiple data layers (i.e. MIMO streams) to the MIMO receiver 320 on a shared communication channel. The second transmitter 315 may further transmit multiple data layers on the shared communication channel. In other words, the transmission of the multiple data layers may occur within a set of shared time and/or frequency resources. Both the first transmitter 310, the second transmitter 315, and the receiver 320 may communicate using spatial multiplexing within the communication channel.

Aspects are described from now on only from the perspective of the first transmitter 310 within a SU-MIMO operation. The skilled person would recognize that in the presence of a MU-MIMO operation, the number of transmit layers may correspond to all number of transmit layers transmitted by MIMO transmitters of the MU-MIMO operation.

In more detail, the first transmitter 310 may transmit a designated transmit symbol using each antenna of the plurality of antennas 311 during the same time and frequency resources. In response to a transmission of multiple transmit symbols by the plurality of antennas 311 of the first transmitter 310, the receiver 320 may receive, by each antenna, a receive symbol, which the received symbol by an antenna of the plurality of antennas 321 of the receiver 320 may be a combination of all transmit symbols transmitted by the plurality of antennas 311 of the first transmitter 310 at the corresponding time and frequency resources, and a noise and channel effects introduced by the communication channel. In order to obtain the designated transmit symbols transmitted by the first transmitter 310, the receiver may perform a MIMO detection algorithm on the received symbols by the plurality of antennas 321 of the receiver 320.

The first transmitter 310 may transmit N transmit signals from N number of antenna 311. Each transmit symbol of N transmit signals at a communication resource may be denoted as s₁ s₂, . . . s_{N}, which may be represented with a transmit symbol vector S=[s₁, s₂, . . . s_{N}]^{T}. The receiver 320 may receive M receive signals using M number of antennas 321. Each receive symbol at a communication resource may be denoted as y₁, y₂, . . . y_{N}, which may be represented with a receive symbol vector Y=[y₁ y₂ . . . y_{M}]^{T}, noting that M may or may not be equal to N. The contribution of all transmit symbols s₁, s₂, . . . s_{N} to each receive symbol may be characterized with a channel matrix H representative of conditions of the communication channel, such that:

$$H = [ \begin{matrix}{h}_{1 , 1} & {h}_{1 , 2} & … & & {h}_{1 , N} \\ {h}_{2 , 1} & {h}_{2 , 2} & … & & {h}_{2 , N} \\ … & … & … & & … \\ {h}_{M , 1} & {h}_{M , 2} & … & & {h}_{M , N}\end{matrix} ]$$

In this channel matrix H, each h_{i,j}, 0<i<M+1; 0<j<N+1, i and j being integers, being a complex coefficient representing the channel response between an antenna j of the plurality of antennas 311 and an antenna i of the plurality of antennas 321. In accordance with the commonly applied linear model of MIMO communication, the receive symbol vector Y may be denoted as below, N denoting a vector representing an additive noise associated with the communication channel:

Y=HS+N

Noting that the first transmitter 310 is a MIMO transmitter configured to transmit multiple data layers, the first transmitter 310 may include a processor configured to perform necessary operations at each data layer of the multiple data layers to obtain MIMO communication signals. For example, a processor (e.g. the digital signal processor 208) may be configured to perform, for each data layer of the multiple data layers, one or more of error detection, forward error correction encoding/decoding, channel coding and interleaving, channel modulation/demodulation, physical channel mapping, antenna diversity processing, interference cancelation, and any other physical layer processing functions.

Illustratively, the processor may obtain a data layer of multiple data layers and encode the data layer for channel coding to obtain an encoded data stream. Then, the processor may perform interleaving and/or scrambling on the encoded data stream to obtain interleaved and/or scrambled data stream. The processor may further perform channel modulation on the interleaved and/or scrambled data stream to convert the interleaved and/or scrambled data stream into a stream of complex symbols, which the processor may perform physical channel mapping and antenna diversity processing to map the stream of complex symbols to the plurality of antennas 311. The processor may perform these operations for each data layer of the multiple data layers to produce MIMO communication signal.

Similarly, noting that the receiver 320 is a MIMO receiver configured to obtain multiple data layers from received MIMO communication signals, the receiver 310 may include a processor configured to perform necessary operations at each data layer of the multiple data layers to obtain multiple data layers. For example, a processor (e.g. the digital signal processor 208) may be configured to perform, for each data layer of the multiple data layers, one or more of error detection, forward error correction encoding/decoding, channel coding and interleaving, channel modulation/demodulation, physical channel mapping, antenna diversity processing, interference cancelation, and any other physical layer processing functions.

Illustratively, the processor may perform physical channel mapping and antenna diversity processing to map the radio communication signals received from the plurality of antennas 321 into a stream of complex symbols, at which the processor uses a MIMO detection algorithm. The processor may further perform channel demodulation on the stream of complex symbols to obtain interleaved and/or scrambled data stream. Then, the processor may perform deinterleaving and/or descrambling on the interleaved and/or scrambled data stream to obtain encoded data stream. Then the processor decode the encoded data stream by channel decoding to obtain a data stream of multiple data streams. The processor may perform these operations for each stream of complex symbols to obtain multiple data layers.

The channel response of the communication channel may vary in time in response to many effecting factors and the receiver 320 may obtain the channel matrix in accordance with commonly known operations periodically or aperiodically to compensate the variations, such as an uplink channel estimation, by transmitting and/or receiving predetermined reference signals to determine channel response, by receiving an estimate channel matrix from the first transmitter 310, etc.

In theory, assuming that the channel matrix H is accurate and N is modeled with sufficient accuracy, in accordance with the receive symbol vector Y, the receiver 320 may determine transmit symbol vector S accurately. Denoting Ŷ=Y−N, the receiver 320 may calculate S=H⁻¹Ŷ which includes an inverse or a pseudo-inverse matrix operation. Although this may be seen as a simple inverse or a pseudo-inverse matrix operation, the solution of the equation to determine S may not exist or may not be unique. Furthermore, as the dimensions of the channel matrix H increases with increasing number of transmit and receive antennas, the computation of the inverse channel matrix may become very challenging, in particular depending on the coefficients in the channel matrix.

In more detail, solving a system of the outlined linear equation may present inherent challenges, including issues related to rounding errors and the nature of the matrix involved. Typically, a processor of the receiver 320 may solve these equations, but storing coefficients in a memory of the receiver 320 may introduce fixed-point or rounding errors. Pivoting may be used as a method to counteract these rounding effects when employing illustratively the Gauss-Jordan elimination procedure, ensuring the proper progression of the Gaussian elimination process. However, issues may arise even in the absence of rounding effects. Minor alterations in input data may also lead to significant changes in the solution. In the context of the outlined linear equation, these solution variations can be also influenced greatly by the presence of the noise N. A robust solution should be resilient against fluctuations in this noise, at least to a certain extent. The sensitivity of the solution to small alterations in the input data is evaluated using the condition number of the transmission matrix (H). This number characterizes the solution's stability (S) concerning slight variations in the incoming data (Y).

This is where the condition number of the channel matrix may become useful. Noting that the condition number of the channel matrix may be denoted with κ(H)=∥H∥∥H⁻¹∥, and the condition number of the channel matrix may be representative of a measure of relative sensitivity of the transmit vector S to the changes in the receive symbol vector and noise combination Ŷ, as the condition number increases, a small change in the receive symbol vector and noise combination Ŷ gets multiplied by the condition number κ(H) and changes the output of the linear equation that would represent the transmit symbol vector S.

Accordingly, a relatively high condition number (e.g. above a threshold) of the channel matrix may indicate that the channel matrix is an ill-conditioned matrix, which may not allow an accurate or unique calculation of the transmit symbol vector S using less complex algorithms that may rely on inverse matrix operations for the channel matrix. Alternatively, a relatively low condition number (e.g. below a threshold) of the channel matrix may indicate that the channel matrix is a well-conditioned matrix and may allow calculation of the transmit symbol vector S with sufficient reliability and accuracy using less complex algorithms that may rely on inverse or pseudo-inverse matrix operations.

A MIMO detection algorithm may include a method that estimates S using the knowledge of {Y, H, and N}, and particularly σ of the variance σ² of each value of the designated additive noise vector (e.g. a complex Gaussian noise vector). One of the optimal detection algorithms may be the sphere decoder. In sphere decoding, the processor may recover the maximum likelihood (ML) estimate of the S. In accordance with various aspects provided herein, the sphere decoding may be one of the MIMO detection algorithms with higher processing complexity. Illustratively, the sphere coding may not use an inverse matrix operation to determine transmit symbol vector S, and may be suitable when the channel matrix is an ill-conditioned channel matrix (i.e. high condition number).

Minimum Mean Square Method (MMSE), on the other hand, may be a widely used MIMO detection method as its performance is good enough for a practical system and has much lower complexity than any ML method. In accordance with various aspects provided herein, the MMSE may be one of the MIMO detection algorithms with lower processing complexity in comparison with the sphere decoding. Illustratively, the MMSE may use an inverse matrix operation to determine transmit symbol vector S, and may not be suitable when the channel matrix is an ill-conditioned channel matrix (i.e. high condition number).

FIG. 4 shows an example of an apparatus according to various examples in this disclosure. The apparatus 400 may be an apparatus of a radio communication device (e.g. the network access node 110, 120, the terminal device 102, 104) of a mobile radio communication network. In cellular communication context, the radio communication device may be a BS (e.g. an evolved node-B (eNB), a next generation node-B (gNB). In a disaggregated radio communication architecture (e.g. Open-Radio Access Network (O-RAN)), the radio communication device may include a distributed unit (e.g. O-DU) or a radio unit (e.g. O-RU) (i.e. depending on the designated split of the protocol stack where MIMO detection is applied). The apparatus 400 may be an apparatus of a MIMO receiver (e.g. the MIMO receiver 320).

The apparatus 400 may include a processor 401, a memory 402, and a communication interface 403 configured to receive and transmit communication signals in order to communicate with further entities within the mobile communication network. In some aspects, the communication interface 403 may include one or more signal paths to carry communication signals. The communication interface 403 may include one or more transceivers. The communication interface 403 may be configured for MIMO communication and beamforming, and thereby may include a plurality of signal paths. Correspondingly, the transceiver included by the communication interface 403 may be a MIMO transceiver including an antenna interface configured to connect to multiple antennas (e.g. to a MIMO array). Additionally, or alternatively, the communication interface 403 may include one or more signal paths to obtain receive signals including receive symbol stream (i.e. receive symbol vectors).

The processor 401 may include one or more processors, which may include a baseband processor and an application processor (e.g. application processor 212, baseband modem 206). In various examples, the processor 401 may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 401 may be implemented in one processing unit, e.g. a system on chip (SOC), or a processor. In accordance with various examples, the processor 401 may further provide further functions to process received communication signals. The memory 402 may store various types of information required for the processor 401, or the communication interface 403 to operate in accordance with various aspects of this disclosure.

The memory 402 may be configured to store, among other things, a plurality of MIMO detection algorithms 404. Illustratively, the information stored in the memory 402 may include necessary instructions to perform various MIMO detection algorithms, and the processor 401 may execute respective instructions to perform a MIMO detection algorithm to determine a transmit signal from a receive signal. The receive signal may include communication signals received from the communication interface 403, which correspond to the information received by one or more multiple antennas via MIMO communication. Illustratively, a receive signal may include a receive symbol vector associated with one radio communication resource, which includes receive symbols received at multiple antennas at the respective radio communication resource.

The plurality of MIMO detection algorithms 404 may include any arbitrary or known MIMO detection algorithm. Illustratively, the plurality of MIMO detection algorithms 404 may include an MMSE detection algorithm, a Zero-Forcing (ZF) detection algorithm, a Block Coordinate Descent (BCD) detection algorithm, a tree search detection algorithm, a maximum a posteriori (MAP) or ML detection algorithm, an expectation-maximization (EM) detection algorithm etc. Accordingly, the memory 402 may store corresponding instructions of each MIMO detection algorithm, so that the processor 401 may access a respective set of instructions to implement one of the MIMO detection algorithms.

The MMSE algorithm in MIMO detection may estimate the transmit symbols by minimizing the mean square error between the receive signal and an estimate signal. Utilizing the receive signal and the channel matrix, the MMSE estimator may employ a matrix inversion operation involving the conjugate transpose of the channel matrix and its inverse, along with an added noise term, to compute estimated symbols. This algorithm may consider both the signal distortion caused by the communication channel and the noise present in the receive signal, to achieve a balance between the two to obtain symbol estimates with sufficient accuracy. While offering an improved performance compared to simpler MIMO detection algorithms, the MMSE algorithm may involve a processing complexity due to the matrix inversion operation, which can become computationally demanding, especially for a larger MIMO system. In accordance with various aspects, the MMSE may be deemed as a MIMO detection with lower processing complexity and with a matrix inverse operation associated with the channel matrix.

The ZF algorithm in MIMO detection may aim to eliminate interference among signals by projecting the receive signal onto a space orthogonal to an interference subspace. Using the receive signal and the channel matrix, ZF may compute an estimate of the transmit symbols by performing a matrix inversion operation involving the pseudo-inverse of the channel matrix. This operation may nullify interference from other transmit signals by inversely manipulating the channel effects, effectively eliminating the inter-stream interference. While ZF may simplify interference cancellation and offer computational efficiency compared to more complex methods, its reliance on a matrix inversion operation can lead to issues like noise amplification and sensitivity to channel estimation errors. In accordance with various aspects, the ZF may be deemed as a MIMO detection with a lower processing complexity and with a matrix inverse operation associated with the channel matrix.

The BCD detection algorithm in MIMO processing may iteratively solve subsets of the transmit symbols. The BCD detection algorithm may include sequentially updating blocks of transmit symbols while fixing the remaining blocks, aiming to minimize the overall mean square error between the receive signal and an estimated signal. Using the receive signal and the channel matrix, BCD may perform iterative updates on subsets of transmit symbols, which are mathematically linked through the channel matrix. The method may further include solving smaller optimization problems within blocks of symbols, reducing the complexity associated with computing the entire solution at once. Although BCD may avoid direct matrix inversions, its iterative nature and sequential updates can result in moderate processing complexity, especially in scenarios with high-dimensional signal constellations or intricate channel conditions. Nonetheless, BCD may offer a trade-off between computational efficiency and performance by iteratively refining symbol estimates based on subsets of variables, making it suitable for certain MIMO systems with constrained processing capabilities. In accordance with various aspects, the BCD may be deemed as a MIMO detection with a moderate processing complexity (i.e. between low processing complexity and high processing complexity) and without a matrix inverse operation associated with the channel matrix.

The tree search detection algorithm in MIMO processing may include an exhaustive search method to find optimal transmit symbols by exploring all possible symbol combinations within a predetermined search tree. The algorithm may utilize the receive signal and the channel matrix, and may systematically examines various symbol configurations to identify the most likely transmit symbol sequence that best matches the receive signal. Unlike direct matrix inversion approaches, tree search detection may not involve matrix operations; instead, it exhaustively evaluates symbol combinations, making it computationally demanding and exponentially complex with larger signal constellations or higher-order MIMO systems. In accordance with various aspects, the tree search detection may be deemed as a MIMO detection with a moderate processing complexity (i.e. between low processing complexity and high processing complexity) and without a matrix inverse operation associated with the channel matrix.

The MAP detection in MIMO processing may estimate the transmit symbols based on both the receive signal and prior probabilities of symbol occurrences. The processor 401 may utilize the receive signal and the channel matrix, and the MAP detection may combine the likelihood of the receive signal given the transmit symbols, the prior probabilities of the symbols, and the channel effects. The processor 401 may calculate a posterior probability of each symbol sequence by incorporating prior information about the symbol probabilities, obtained through statistical models and/or channel characteristics. While offering improved performance compared to Maximum Likelihood (ML) in scenarios with prior knowledge, MAP detection may involve computationally intensive calculations due to its reliance on iterative algorithms and the incorporation of prior probabilities. In accordance with various aspects, the MAP detection may be deemed as a MIMO detection with a high processing complexity and without a matrix inverse operation associated with the channel matrix.

The ML detection in MIMO processing may estimate the transmit symbols by exhaustively searching through all possible symbol combinations to identify the sequence that maximizes the likelihood of producing the received signal, sometimes complimenting to a tree search detection algorithm. The processor 401 may utilize the receive signal and the channel matrix, and ML detection may compute the probability of the receive signal given each possible transmitted symbol sequence. The processor 401 may perform an exhaustive search across the symbol space to evaluate the likelihood of each symbol sequence to determine the most probable transmit symbols. The ML detection does not inherently involve matrix inversion operations but it may entail high computational complexity due to its exhaustive search nature, making it computationally demanding, especially for larger signal constellations or higher-dimensional MIMO systems. In accordance with various aspects, the ML detection may be deemed as a MIMO detection with a high processing complexity and without a matrix inverse operation associated with the channel matrix.

The EM detection technique in MIMO processing may include an iterative algorithm aimed at to estimate the transmit symbols by iteratively refining estimates based on the receive signal and the channel matrix. EM detection may initialize with initial estimates and iteratively alternates between two steps: the expectation (E) step and the maximization (M) step. In the E-step, the processor 401 may compute the expected values of the missing or unobserved variables, considering the receive signal and the current estimates. In the M-step, the processor 401 may maximize the likelihood function, updating the estimates based on the expected values calculated in the previous step. EM detection may iterate between these steps until convergence, to refine symbol estimates without directly relying on matrix inversion operations. In accordance with various aspects, the EM detection may be deemed as a MIMO detection with a high processing complexity and without a matrix inverse operation associated with the channel matrix.

There are numerous MIMO detection algorithms, some of whose performance and complexity lie in between that of MMSE and ML methods. The bit error rate (BER) improvement associated with such algorithms that may achieve over MMSE is not the same under varying channel conditions. For example, when the gram matrix of the channel matrix H is denoted as G=H^{H}H (hereafter referred to as gram matrix in this disclosure for brevity) is diagonally dominant at an extent (e.g. diagonal dominance is over a designated value), the MMSE estimate of the transmit signal may be close to that of ML estimate of the transmit signal, and hence, other MIMO detection algorithms, some of which may be more processing complexity and computation overhead, improve little over MMSE despite the increase in complexity, as they may not outperform the ML bound.

It is to be noted that the apparatus 400 may have associated with a communication channel (e.g. a MIMO communication channel) for communication operations with one or more further radio communication devices. The processor 401 may obtain information representative of conditions of the communication channel. In some examples, the processor 401 may obtain the channel matrix that is representative of the conditions of the communication channel. In some examples, the processor 401 may use any known methods to perform calculations to estimate and/or obtain the channel matrix.

Illustratively, the processor 401 may be configured to perform channel estimations based on one or more channel estimation methods. Illustratively, one or more antennas connected to or included by apparatus 400 may receive radio communication signals including reference signals. RF circuits connected to the one or more antennas may transform received radio communication signals into baseband signals, along with other operations including amplification, refinement, etc. Accordingly, the processor 401 may obtain baseband signals obtained from the received radio communication signals. The processor 401 may further provide digital front-end processing to the baseband signals to refine received baseband signals. The processor 401 may perform channel estimations based on the one or more channel estimation methods on the baseband signals.

In accordance with various aspects provided herein, the processor 401 may estimate a bit error rate (BER) gap degree between an MMSE estimate of a received radio signal using the communication channel (e.g. receive signal). and an ML estimate of the received radio signal using the communication channel. The processor 401 may perform calculations that coarsely estimate the BER of the MMSE detection. The processor 401 may perform further calculations that coarsely estimate the BER of the ML detection. The processor may accordingly determine the BER gap degree based on these coarse estimated BERs. A coarse estimation of the BER gap between two estimates may be sufficient for the processor 401 to select a MIMO detection algorithm from the plurality of MIMO detection algorithms. The processor 401 may accordingly use the selected MIMO detection algorithm to determine transmit signals (e.g. one or more transmit symbol vectors) based on receive signals (e.g. one or more respective receive symbol vectors).

It is further to be noted that, any MIMO detection algorithm, in particular the ones described herein, may perform strongly under certain channel conditions and poorly in some others. When the processor 401 use a selected MIMO detection algorithm to determine transmit signal (e.g., per subcarrier or a group of subcarriers in a received OFDM symbol), the processor 401 may select the optimal MIMO detection algorithm (which may include MMSE) with the knowledge of the channel matrix with only a little increase in the complexity. In some channel conditions, the optimal MIMO detection algorithm may be the MMSE, in particular when channel condition is such that other MIMO detection algorithms may not improve much over the MMSE. In some examples, the optimal MIMO detection algorithm may be an iterative near-ML algorithm that may achieve several dB of improvement over the MMSE with little increase in complexity when, for example, channel matrix has a high condition number and high off-diagonal dominance.

In accordance with various aspects described herein, the processor 401 may be configured to select a MIMO detection algorithm from the multiple available MIMO detection algorithms, such that there is an optimal tradeoff between processing complexity/computation overhead and estimation performance (e.g. accuracy) of the available MIMO detection algorithms. Eventually, by selecting a MIMO detection algorithm with less processing complexity resulting in a sufficient estimation accuracy, the apparatus 400 may conserve computation resources which the processor 401 may use for other purposes or consume less power per one MIMO detection. Alternatively, by selection a MIMO detection algorithm with higher processing complexity, the processor 401 may obtain desired estimation accuracy in challenging channel conditions. As described herein, the selection of the MIMO detection algorithm may be based on a prediction of a BER gap degree between estimates of a MIMO algorithm of a lower processing complexity, such as MMSE, and of a MIMO algorithm of a higher processing complexity, such as ML estimation. The predicted BER gap degree may be a coarse estimation of whether the BER gap is high (e.g. the difference between predicted coarse BERs is above a designated threshold) or low (e.g. the difference between predicted coarse BERs is below a designated threshold).

In accordance with various aspects provided herein, the processor 401 may select the MIMO detection algorithm based on how well condition the channel matrix is. In some examples, the processor 401 may select the MIMO detection algorithm further based on a diagonal dominance of the gram matrix and/or spatial covariance matrix associated with the communication channel.

The processor 401 may obtain a Gram matrix of the channel matrix by multiplying the channel matrix by its conjugate transpose. In various aspects described herein, the processor 401 may use the Gram matrix G instead of the channel matrix H, as the Gram matrix generally offers a more manageable and insightful representation of the spatial relationships inherent in the MIMO communication channel, allowing for more efficient calculations and optimizations in various MIMO-related tasks, which may provide advantages in various cases for computation. It is however to be noted that the processor 401 may use the channel matrix H instead of the gram matrix G in any aspect described herein for the selection of a MIMO detection algorithm.

Furthermore, the processor 401 may determine a spatial covariance matrix associated with the communication channel. The spatial covariance matrix in the context of MIMO systems may characterize the statistical relationships between different antennas within the multiple antennas that receive the MIMO communication signal. It may represent the covariance or correlation between the receive signals received by different antennas. In the case of MIMO, where there are multiple antennas at both ends, the spatial covariance matrix may capture the correlations among the receive signals across different antennas at the receiver. For instance, in a receive spatial covariance matrix as for the apparatus 400, the diagonal elements may represent the power levels or variances of the receive signals at each antenna of the MIMO communication, while the off-diagonal elements may denote the correlations between different antennas.

The processor 401 may determine a class for a condition number of the channel matrix from a plurality of classes. As mentioned before, an actual calculation of the condition number of the channel matrix may include various challenges, in particular with respect to processing complexity and delays associated with the calculation. For the purpose, the processor 401 may determine a class for the condition number, such that the class may represent a degree of well-conditioned the channel matrix is. In other words, the class of the condition number may provide a representation about the magnitude of the condition number. Illustratively, the class may be representative of a magnitude interval for the condition number, such that if the condition number was calculated, it would fall within that particular magnitude interval. Noting that aspects are described herein for the Gram matrix instead of the channel matrix with respect to the advantages mentioned before, the processor 401 may determine a class for a condition number of the Gram matrix. Illustratively, there may be 2, 3, 4, 5 or more classes. In accordance with various aspects provided herein, the processor 401 may determine the class for the condition number of the channel matrix using a neural network based classifier.

Further, the processor 401 may determine a diagonal dominance of the Gram matrix (or the channel matrix) and/or the spatial covariance matrix as a further indication for the selection of the MIMO detection algorithm. It is to be noted that the processor 401 may determine any type of metric indicative of the diagonal dominance of the Gram matrix and/or the spatial covariance matrix. In particular, the processor 401 may determine an off-diagonal dominance of the Gram matrix and/or the spatial covariance matrix. With an approach that is made similar to the condition number, the processor 401 may determine a degree (or a class) of the off-diagonal dominance, which the degree (or the class) represents a magnitude interval of the off-diagonal dominance. Illustratively, there may be 2, 3, 4, 5 or more degrees or classes.

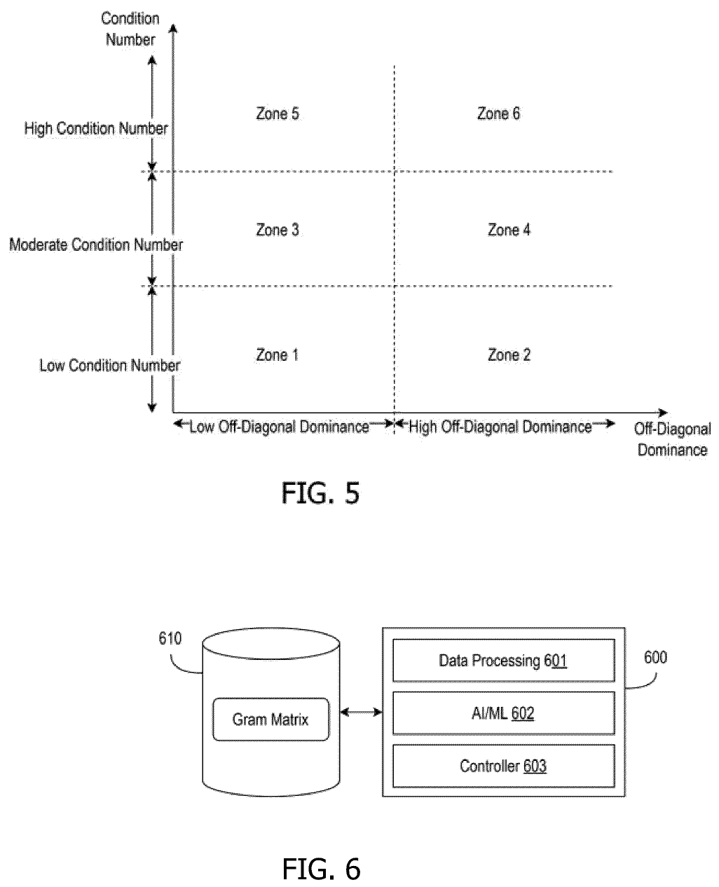

FIG. 5 shows an exemplary illustration of a graph of a condition number and an off-diagonal dominance of a Gram matrix (or a Channel matrix). As illustrated herein, a first class is designated for the condition number between 1 and a first coarse condition number (e.g. A) as a first interval depicted as low condition number class. A second class is designated for the condition number between the first coarse condition number and a second coarse condition number as a second interval depicted as moderate condition number class. A third class is designated for the condition number between the second coarse condition number and a third coarse condition number as a third interval depicted as high condition number class. Based on a calculated coarse condition number, a processor (e.g. the processor 401) may determine the class of the condition number based on designated intervals. A memory (e.g. the memory 402) may store information representative of a mapping between classes and calculated coarse condition numbers, such as corresponding thresholds or intervals to determine a class for the condition number based on a calculated coarse condition number. It is to be noted that the processor may determine these classes by performing, at most, O(N²) operations.

Illustratively, for a determined class of the condition number, the processor may select a MIMO detection algorithm from a plurality of MIMO detection algorithms. For example, the processor may select a first MIMO detection algorithm with a low computing overhead if the determined class of the condition number is the low condition number class. Similarly, the processor may select a second MIMO detection algorithm with a moderate computing overhead if the determined class of the condition number is the moderate condition number class, or may select a third MIMO detection algorithm with a high computing overhead if the determined class of the condition number is the high condition number class.

As mentioned before, any MIMO detection algorithm may not result in the most accurate estimate of transmit symbols, or may be the most optimal one given the system and channel conditions. While in certain cases, MIMO detection algorithms including inverse matrix operations may be optimal, in some cases the accuracy of such algorithms may not be sufficient and iterative algorithms may be preferable. In order to provide more context with respect to the channel conditions, the processor may select the MIMO detection algorithm further based on off-diagonal dominance of the Gram matrix or the spatial covariance matrix.

As illustrated herein, a first class is designated for the off-diagonal dominance of the Gram matrix or the spatial covariance matrix between 0 and a first off-diagonal dominance value as a first interval depicted as low off-diagonal dominance class. A second class is designated for the off-diagonal dominance value greater than the first off-diagonal dominance value depicted as a high off-diagonal dominance class. In some examples, the low off-diagonal dominance may indicate a diagonal dominance state of the Gram matrix or the spatial covariance matrix, and the high off-diagonal dominance may indicate an off-diagonal state of the Gram matrix or the spatial covariance matrix. The processor may calculate the off-diagonal dominance value from the Gram matrix or the spatial covariance matrix in accordance with this equation, which the off-diagonal dominance value may indicate as a metric whether the matrix is of a diagonal dominance state or of an off-diagonal dominance state, g_{i,j} being i, j coefficient of illustratively the Gram matrix:

$$\frac{{\sum }_{{i , j}_{i \neq j}} {\vert {g}_{i , j} \vert}^{2}}{{\sum }_{{i , j}_{i = j}} {\vert {g}_{i , j} \vert}^{2}}$$

Furthermore, zones 1-6 have been illustrated herein to define various cases based on the classes of the condition number and the classes of the off-diagonal dominance. Illustratively, zone 1 represents a case in which the processor determines the low condition number class and the low off-diagonal dominance class. Zone 2 represents a case in which the processor determines the low condition number class and the high off-diagonal dominance class. Zone 3 represents a case in which the processor determines the moderate condition number class and the low off-diagonal dominance class. Zone 4 represents a case in which the processor determines the moderate condition number class and the high off-diagonal dominance class. Zone 5 represents a case in which the processor determines the high condition number class and the low off-diagonal dominance class. Zone 6 represents a case in which the processor determines the high condition number class and the high off-diagonal dominance class.

In various aspects, the processor may select the MIMO detection algorithm based on the condition number class and the off-diagonal dominance class, as depicted herein. Illustratively, zone 1 may indicate that there is a small BER gap between MMSE estimate and ML estimate, hence, the processor may select MMSE or other similar MIMO detection algorithms with lower processing complexity in this case.

Although, zone 2 represents the low condition number class, in this case high off-diagonal dominance class may be a rare occurrence, which may still result in inaccurate estimates with the MMSE. So, the processor may select a MIMO detection algorithm including Bayesian and/or other iterative methods, but which may still include inverse matrix operations that may also use other metrics such as residual norms.

Zone 4 may indicate a moderate BER gap between MMSE estimate and ML estimate, and similar to zone 2, the processor may select a MIMO detection algorithm including Bayesian and/or other iterative methods, but which may still include inverse matrix operations that may also use other metrics such as residual norms. It is to be noted that tradeoff between complexity and BER improvement resulting in using MIMO detection algorithms other than the MMSE. Zone 3 may indicate a large BER gap between MMSE estimate and ML estimate, and while the processor may select a MIMO detection algorithm including Bayesian and/or other iterative methods, but which may still include inverse matrix operations that may also use other metrics such as residual norms, it may also be preferable to opt for more complex and iterative MIMO algorithms, such as ML detection, MAP detection, EM detection.

Zones 5 and 6 may indicate a very large BER gap between MMSE estimate and ML estimate and in these cases, the processor may select a MIMO detection algorithm that is iterative in nature and predominantly use some residual norm as a metric. If the iterative method converges to ML asymptotically, the per iteration BER improvement against MMSE will be the highest in this zone and hence, only a few iterations suffice to achieve significant gain against MMSE. Illustratively, the processor may select ML detection, tree search detection, BCD detection, etc.

In accordance with various aspects provided herein, the processor may determine the class of the condition number of the channel matrix (or the gram matrix) using an NN-based classifier. The NN-based classifier may include a neural network.

FIG. 6 shows an example of a processor and a memory of a device according to various aspects provided in this disclosure, in particular configurable as an NN-based classifier. The processor 600 is depicted to include various functional units that are configured to provide various functions as disclosed herein, associated with a processor (e.g. the processor 401) that may be used within a device (e.g. the device 400). The skilled person would recognize that the depicted functional units are provided to explain various operations that the processor 600 may be configured to perform. Furthermore, the NN unit 602 is depicted as it is implemented in the processor 600 only as an example, and any type of AI/ML implementation which may include the implementation of the AI/ML in an external processor, such as an accelerator, a graphics processing unit (GPU), a neuromorphic chip, or in a cloud computing device, or in an external communication device may also be possible according to any methods.

The processor 600 may include a data processing unit 601 that is configured to process data and obtain at least the channel matrix as provided in various examples in this disclosure to be stored in the memory 610. In some examples, the data processing unit 601 may calculate the Gram matrix, and/or the spatial covariance matrix. The data processing unit 601 may further determine the off-diagonal dominance of the Gram matrix and/or the spatial covariance matrix.

The data processing unit 601 may further implement feature extraction operations. It is to be considered that the NN implemented by the NN unit 602 may have certain constraints, some of which may relate to the structure and aspects of the data to be inputted to the NN. The feature extraction operations may include translating (i.e. transforming) the Gram matrix into input data of the NN.

The NN unit 602 may implement one or more NNs. The aspects are provided for one NN but it may also include applications involving more than one NNs. The NN may be configured to receive input data with certain constraints, features, and formats. Accordingly, the data processing unit 601 may obtain input data, that is based on the Gram matrix (or the channel matrix), to be provided to the NN to obtain an output of the NN (e.g. a class of the condition number and/or a coarse condition number). In various examples, the data processing unit 601 may provide input data including the Gram matrix to the NN. In various examples, the data processing unit 601 may convert the Gram matrix to an input format suitable for the NN (i.e. feature extraction e.g. to input feature vectors) so that the NN may process.

In accordance with various aspects provided herein, the NN included in the NN unit 602 may be trained to learn to approximate the condition number of the Gram matrix (or the channel matrix) using Gershgorin discs associated with the Gram matrix. The Gershgorin discs may have the diagonal entries of the Gram matrix as their centers respectively, and the respective absolute row sums as their radii. In other words, for the Gram matrix G, there may be N number of Gershgorin discs (N being number of transmit data layers), such that the center of each j-th disc is the j-th diagonal element of G, and the radius of each respective j-th disc is the sum of the magnitudes of the off-diagonal elements of the j-th row in the matrix G.

In such an example, the NN may be configured to output a condition number (i.e. a coarse condition number or a condition number estimate) for a Gram matrix, based on input data including the diagonal elements of the Gram matrix and a corresponding sum of magnitudes of off-diagonal elements of the Gram matrix, and NN parameters (i.e. weights, biases, etc.) designated to provide the learnt approximation.

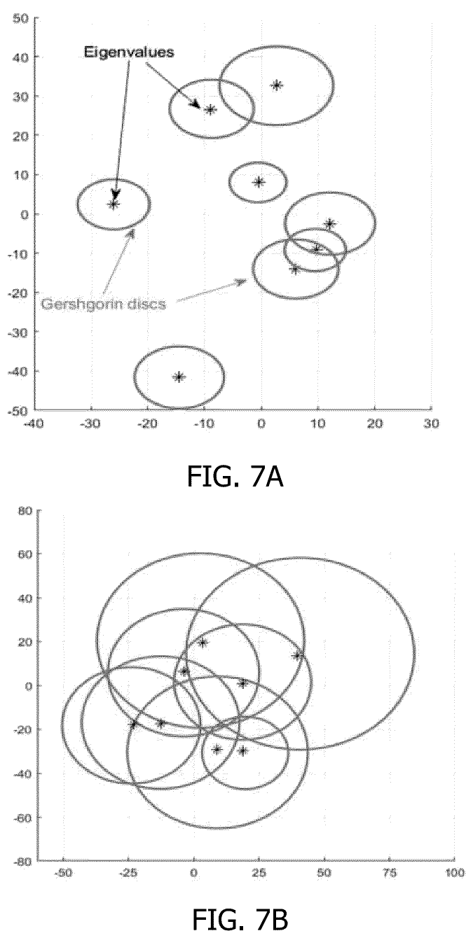

FIG. 7A shows an exemplary illustration of a graph showing Gershgorin discs of a diagonally dominant matrix along with the eigenvalues of the same matrix, and FIG. 7B shows an exemplary illustration of a graph showing Gershgorin discs of an arbitrary random channel matrix along with the eigenvalues of the same matrix. Illustratively, the Gershgorin discs may guarantee to contain all the eigen values of a matrix. The discs' extremal values may have no practical use (see FIG. 7B). However, the amount of overlap between each of the discs, the distance between center of the discs, distance between the edges of the discs, etc. may convey some information about how many eigen values lie in a disc, how tight the disc boundaries are, etc. Although theoretical characterization of the extremal eigenvalues using Gershgorin discs may be challenging, a NN may coarsely estimate the condition number of the channel matrix when its inputs are the centers and the radii (normalized) of the Gershgorin discs.

Referring back to FIG. 6, it is to be noted that the NN may have trained to learn to approximate the condition number of the Gram matrix (or the channel matrix) using Gershgorin discs associated with the Gram matrix as indicated via a supervised training. Illustratively, the NN may have been trained with training data including training input data and training output data pairs. Each training input data may include, for a previously obtained Gram matrix, information representing center of each j-th disc as the j-th diagonal element of the previously obtained Gram matrix, and the radius of each respective j-th disc as the sum of the magnitudes of the off-diagonal elements of the j-th row in the previously obtained matrix G. In other words, each training input data may include a feature vector comprising a plurality of diagonal elements of a corresponding gram matrix and a corresponding sum of magnitudes of off-diagonal elements of the corresponding gram matrix for each diagonal element of the plurality of diagonal elements of the gram matrix. Training output data for each training data pair may include a condition number previously calculated for the respective Gram matrix in the respective training input data. By providing many training data pairs as described herein, the NN may learn to approximate the condition number of a Gram matrix based on input data including the diagonal elements of the Gram matrix and a corresponding sum of magnitudes of off-diagonal elements of the Gram matrix.

In some examples, based on various conditions, Gram matrices used as input to the NN may have a large range of condition numbers, such as 1 to 1000. When the condition numbers can have such large variations, the mean square error (MSE) minimization during training may heavily bias the NN towards estimating the high condition numbers more accurately than the lower condition numbers (such as those below 100). Therefore, for such cases, the NN may be configured to learn to approximate the logarithm of the condition number instead of the condition number itself. It is to be noted that in this case, the training output data of training data pair would include the calculated logarithm of the condition number associated with the Gram matrix used in the respective training input data.

In some examples, the NN may be configured to output a condition number (i.e. a coarse condition number or a condition number estimate) for a Gram matrix, based on input data including the diagonal elements of the Gram matrix and a corresponding sum of magnitudes of off-diagonal elements of the Gram matrix, singular values of the Gram matrix, and NN parameters (i.e. weights, biases, etc.) designated to provide the learnt approximation. It is to be noted that in this case, the training input data of training data pair would include the calculated singular values of the respective Gram matrix used in the respective training input data.

Illustratively, the data processing unit 601 may perform calculations to estimate the singular values of the Gram matrix before forming the input data of the Gram matrix. For example, the data processing unit 601 may use any commonly known methods, such as the power method being algebraic maximum singular value estimation algorithm, to estimate the maximum singular value. It is to be noted that the minimum singular value may be hard to estimate algebraically, which may also be used within the input data. Accordingly, the data processing unit may feed maximum singular value estimated after 1-2 iterations in the power method to the NN. Illustratively, the condition number may be the ratio of the maximum singular value and the minimum singular value.

Through expanding the input data with the singular values of the Gram matrix, the accuracy of the NN may increase. Furthermore, the NN may, via one or more of its layers, be configured to estimate the least singular value based on the input data, and the NN may, via one or more of its further layers following the one or more of its layers, compute the condition number.

The processor 600 may further include a controller 603 to control the AI/ML unit 602. The controller 603 may provide the input data to the AI/ML, or provide the AI/ML unit 602 instructions to obtain the output. The controller 603 may further be configured to perform further operations of the processor 600 or the device associated with the processor in accordance with various aspects of this disclosure. In particular, the controller 603 may, based on the condition number calculated by the NN unit 602, determine a class of the condition number in accordance with various aspects as described herein.

The NN included in the NN unit 602 may be any type of artificial NN. The NN may include any number of layers, including an input layer to receive the input data, an output layer to provide the output data. A number of layers may be provided between the input layer and the output layer (e.g. hidden layers). The training of the neural network (e.g., adapting the layers of the neural network, adjusting NN parameters) may use or may be based on any kind of training principle, such as backpropagation (e.g., using the backpropagation algorithm).

For example, the NN may be a feed-forward neural network in which the information is transferred from lower layers of the neural network close to the input to higher layers of the neural network close to the output. Each layer may include neurons that receive input from a previous layer and provide an output to a next layer based on certain NN (e.g. weights) parameters adjusting the input information.

The NN may include a recurrent neural network in which neurons transfer the information in a configuration in which the neurons may transfer the input information to a neuron of the same layer. Recurrent NNs (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, and processing, and estimations using time series data.

An LSTM network may include a network of LSTM cells that may process the attributes provided for an instance of time as input data, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the NN may be configured in top-down configuration in which a neuron of a layer provides output to a neuron of a lower layer, which may help to discriminate certain features of an input.

The NN may include a convolutional neural network (CNN), which is an example for feed-forward NN that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The NN may include a generative NN. The generative NN may process input data in order to generate new sets, hence the output data may include new sets of data according to the purpose of the NN. In various examples, the NN may include a generative adversarial network (GAN) model in which a discrimination function is included with the generation function, and while the generation function may generate the data according to model parameters of the generation function and the input data, the discrimination function may distinguish the data generated by the generation function in terms of data distribution according to model parameters of the discrimination function. In accordance with various aspects of this disclosure, a GAN may include a deconvolutional NN for the generation function and a CNN for the discrimination function.

The NN may include a trained NN that is configured to provide the output as provided in various examples in this disclosure based on the input data and one or more NN parameters obtained by the training. The trained NN may be obtained via an online and/or offline training. A training agent may perform various operations with respect to the training at various aspects, including online training, offline training, and optimizations based on the inference results. The NN may take any suitable form or utilize any suitable technique for training process. For example, the NN may be trained using supervised learning, semi-supervised learning, unsupervised learning, or reinforcement learning techniques.

In supervised learning, the NN may be obtained using a training dataset including both inputs and corresponding desired outputs (as described illustratively above). Each training instance may include one or more input data item and a desired output. The training agent may train the NN based on iterations through training instances and using an objective function to teach the NN to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the NN parameters based on outputs and inputs (i.e. output data and input data). The training agent may train the NN according to the desired outcome. The training agent may provide the training data to the NN to train the NN. In various examples, the processor 600 and/or the NN unit 602 itself may include the training agent, or another entity that may be communicatively coupled to the processor may include the training agent and provide the training data to the device, so that the processor may train the NN.

In various examples, the device may include the NN in a configuration that it is already trained (e.g. the NN parameters in a memory are already set for the purpose described as above). It may desirable for the NN itself to have the training agent, or a portion of the training agent, in order to perform optimizations according to the output of inferences as provided in this disclosure. The NN may include an execution unit and a training unit that may implement the training agent as provided in this disclosure for other examples. In accordance with various examples, the training agent may train the NN based on a simulated environment that is controlled by the training agent according to similar considerations and constraints of the deployment environment.

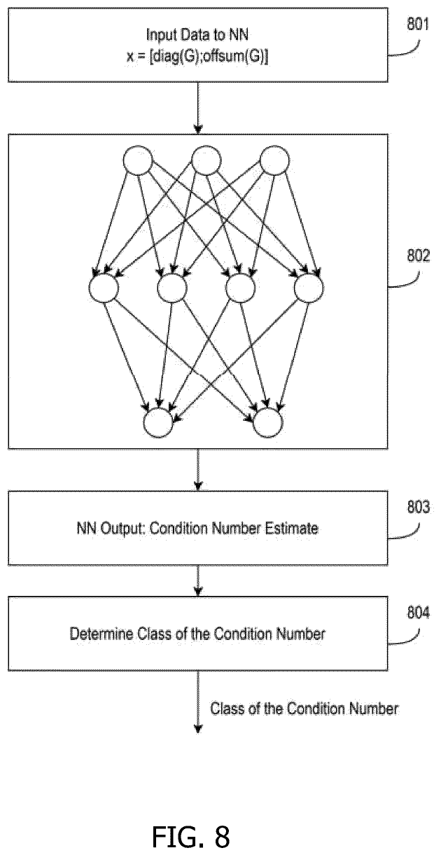

FIG. 8 shows an illustration of a flow diagram to determine a class of a condition number of a Gram matrix (or channel matrix). In accordance with various aspects provided herein, a processor (e.g. the processor 401, the processor 600) may perform operations described herein.

The processor may generate 801 input data to be used by the NN (e.g. the NN unit 602). The NN may be a trained NN configured to receive input data including information representative of Gershgorin discs of a Gram matrix G obtained from a channel matrix representative of channel conditions of a MIMO communication channel for which a MIMO detection algorithm is to be selected. Illustratively, the processor (e.g. the data processing unit 601) may generate the input data including diagonal elements of the Gram matrix G (i.e. diag(G)) and for each diagonal element of the Gram matrix G, a sum of magnitudes of off-diagonal elements of the corresponding gram matrix for the respective diagonal element (i.e. offsum(G)).

The processor may provide the input data to an input layer of a NN 802. Illustratively, the NN may be a multi-layer perceptron (MLP). The MLP may include layers of nodes (neurons), including the input layer, one or more hidden layers, and an output layer. Each node in one layer may be connected to every node in the subsequent layer, and these connections may have associated weights that have been adjusted during the training of the NN as described before. Illustratively, the MLP may be an MLP with hyperbolic tangent (tanh) activation function and/or saturated linear (satlin) activation function. In other words, activation functions in the nodes of the MLP may be tanh activation functions and/or satlin activation functions across the layers.

It is to be noted that, when the singular values of the channel matrix are distributed uniformly, assuming a 8×8 Gram matrix and with 16×4×4×4 sized fully-connected MLP, the detection rates may be above 99% and false alarm rates may be less than 0.5% for low and high zones and the detection rate may be over 90% and false alarm rate may be less than 5% for the mid zone.

In accordance with described herein, the NN 802 may output 803 a condition number (i.e. a coarse condition number, a condition number estimate). Based on the output condition number, the processor (e.g. the controller 603) may determine a class of the condition number, which may indicate a magnitude of the condition number from a higher level as described in this disclosure. Illustratively, the class of the condition number may indicate whether the condition number of the Gram matrix is above a designated condition number value or below a designated condition number value. The class of the condition number may further indicate whether the condition number of the Gram matrix is between two condition number values. The processor may determine the class of the condition number based on configuration information stored in a memory that maps the output condition number into a class of magnitude.

Accordingly, based on the class of the condition number, and optionally further based on a calculated off-diagonal dominance of the Gram matrix or the spatial covariance matrix associated with the MIMO communication channel, the processor may select one of the MIMO detection algorithms from available MIMO detection algorithms that can be used for MIMO detection. The processor may, using the selected MIMO algorithm, determine the transmit signals (e.g. one or more transmit symbol vectors) based on receive signals (e.g. one or more respective receive symbol vectors). After determination of a transmit symbol vector, the processor may pass the determined transmit symbol vector into further operations associated with decoding of the received communication signals.

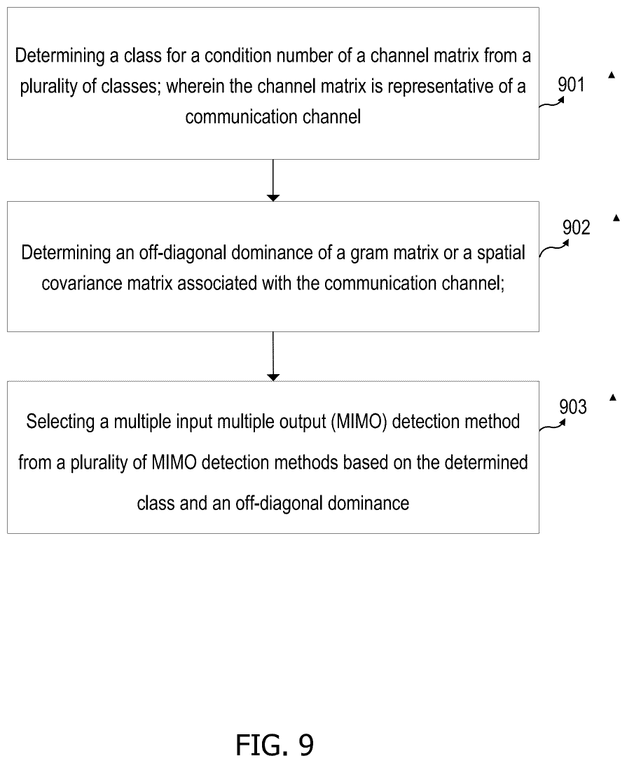

FIG. 9 shows an exemplary illustration of a method. The method may include determining 901 a class for a condition number of a channel matrix from a plurality of classes; wherein the channel matrix is representative of a communication channel; determining 902 an off-diagonal dominance of a gram matrix or a spatial covariance matrix associated with the communication channel; and selecting 903 a multiple input multiple output (MIMO) detection method from a plurality of MIMO detection methods based on the determined class and an off-diagonal dominance. A non-transitory computer-readable medium may include instructions which, if executed by a processor, cause the processor to perform the method.

The following examples pertain to further aspects of this disclosure.

In example 1, the subject matter includes an apparatus that may include a processor configured to: determine a class for a condition number of a channel matrix from a plurality of classes; wherein the channel matrix is representative of a communication channel; determine an off-diagonal dominance of a gram matrix or a spatial covariance matrix associated with the communication channel; select a multiple input multiple output (MIMO) detection method from a plurality of MIMO detection methods based on the determined class and an off-diagonal dominance.

In example 2, the subject matter of example 1, wherein the processor is configured to estimate a bit error gap degree between a minimum mean square estimation (MMSE) estimate of a received radio signal using the communication channel and a maximum likelihood (ML) estimate of the received radio signal.

In example 3, the subject matter of example 1 or example 2, wherein each class of the plurality of classes is representative of a corresponding interval of a magnitude of the condition number.

In example 4, the subject matter of example 3, wherein the plurality of classes includes a first class representative of a first interval of the magnitude of the condition number, a second class representative of a second interval greater than the first interval, and a third class representative of a third interval greater than the second interval.

In example 5, the subject matter of any one of examples 1 to 4, wherein the plurality of MIMO detection methods includes a first MIMO detection method with a first computing overhead, a second MIMO detection method with a second computing overhead greater than the first computing overhead.

In example 6, the subject matter of example 5, wherein the processor is further configured to select one of the first MIMO detection method or the second MIMO detection method according to a calculated metric based on at least the off-diagonal dominance of the gram matrix and a threshold.

In example 7, the subject matter of example 6, wherein the processor is further configured to select the second MIMO detection method over the first MIMO detection method if the calculated metric is above the threshold.

In example 8, the subject matter of any one of examples 1 to 7, wherein the plurality of MIMO detection methods includes at least one of an MMSE detection, a Zero-Forcing (ZF) detection, a Block Coordinate Descent (BCD) detection, a tree search detection, a maximum a posteriori (MAP) or ML detection, an expectation-maximization (EM) detection.

In example 9, the subject matter of any one of examples 1 to 8, wherein the off-diagonal dominance includes a diagonal dominance state and an off-diagonal dominance state.

In example 10, the subject matter of any one of examples 1 to 9, wherein the processor is configured to calculate the off-diagonal dominance of the gram matrix or the spatial covariance matrix.

In example 11, the subject matter of any one of examples 1 to 10, wherein the processor is configured to determine the class for the condition number of the channel matrix using a neural network-based classifier.

In example 12, the subject matter of example 11, wherein the neural network-based classifier includes a trained neural network configured to receive input data representative of Gershgorin discs of the gram matrix and provide output data representative of the class for the condition number of the channel matrix.

In example 13, the subject matter of example 12, wherein the input data includes a feature vector may include a plurality of diagonal elements of the gram matrix and a corresponding sum of magnitudes of off-diagonal elements of the gram matrix for each diagonal element of the plurality of diagonal elements of the gram matrix.

In example 14, the subject matter of example 12 or 13, wherein the trained neural network is configured to calculate a condition number estimate of the channel matrix; wherein the class for the condition number of the channel matrix is classified based on the condition number estimate.

In example 15, the subject matter of example 12 or 13, wherein the trained neural network is configured to calculate a logarithmic condition number estimate of the channel matrix and classify the class for the condition number of the channel matrix based on the condition number estimate.

In example 16, the subject matter of any one of examples 12 to 15, wherein the input data further includes information representative of one or more singular values of the channel matrix.

In example 17, the subject matter of example 16, wherein the processor is further configured to estimate a maximum singular value associated with the channel matrix; wherein the input data further includes the maximum singular value associated with the channel matrix.

In example 18, the subject matter of example 17, wherein the processor is further configured to estimate the maximum singular of the channel matrix based on a power method for calculation of one or more singular values.

In example 19, the subject matter of example 18, wherein the trained neural network is further configured to estimate a minimum singular value of the channel matrix; wherein the output data is based on the minimum singular value of the channel matrix.

In example 20, the subject matter of example 19, wherein the condition number of the channel matrix is a ratio of the maximum singular value and the minimum singular value.

In example 21, the subject matter of any one of examples 1 to 20, may further include a transceiver configured to provide a plurality of receive signals of a MIMO communication.

In example 22, the subject matter of any one of examples 1 to 21, may further include a plurality of antennas configured to receive the plurality of receive signals via the communication channel.

In example 23, the subject matter of any one of examples 1 to 22 wherein the processor is further configured to use the selected MIMO detection algorithm to determine received communication signals.

In example 24, An apparatus may include a processor configured to: estimate an order of magnitude of a condition number of a channel matrix; wherein the channel matrix is representative of a communication channel; determine a degree of an off-diagonal dominance of a gram matrix or a spatial covariance matrix associated with the channel matrix; determine a multiple input multiple output (MIMO) detection algorithm from a plurality of MIMO detection algorithms based on the order of magnitude of the condition number and the degree of the off-diagonal dominance.

In example 25, the subject matter of example 24, wherein the apparatus is further configured in accordance with various aspects described in any one of examples 2 to 24, or any other example in the disclosure.

In example 26, the subject matter includes a non-transitory computer-readable medium that may include instructions which, if executed by a processor, cause the processor to: determine a class for a condition number of a channel matrix from a plurality of classes; wherein the channel matrix is representative of a communication channel; determine an off-diagonal dominance of a gram matrix or a spatial covariance matrix associated with the communication channel; select a multiple input multiple output (MIMO) detection method from a plurality of MIMO detection methods based on the determined class and an off-diagonal dominance.

In example 27, the subject matter of example 26, wherein the instructions further cause the processor to estimate a bit error gap degree between a minimum mean square estimation (MMSE) estimate of a received radio signal using the communication channel and a maximum likelihood (ML) estimate of the received radio signal.

In example 28, the subject matter of example 26 or example 27, wherein each class of the plurality of classes is representative of a corresponding interval of a magnitude of the condition number.

In example 29, the subject matter of example 28, wherein the plurality of classes includes a first class representative of a first interval of the magnitude of the condition number, a second class representative of a second interval greater than the first interval, and a third class representative of a third interval greater than the second interval.

In example 30, the subject matter of any one of examples 26 to 29, wherein the plurality of MIMO detection methods includes a first MIMO detection method with a first computing overhead, a second MIMO detection method with a second computing overhead greater than the first computing overhead.

In example 31, the subject matter of example 30, wherein the instructions further cause the processor to select one of the first MIMO detection method or the second MIMO detection method according to a calculated metric based on at least the off-diagonal dominance of the gram matrix and a threshold.

In example 32, the subject matter of example 31, wherein the instructions further cause the processor to select the second MIMO detection method over the first MIMO detection method if the calculated metric is above the threshold.

In example 33, the subject matter of any one of examples 26 to 32, wherein the plurality of MIMO detection methods includes at least one of an MMSE detection, a Zero-Forcing (ZF) detection, a Block Coordinate Descent (BCD) detection, a tree search detection, a maximum a posteriori (MAP) or ML detection, an expectation-maximization (EM) detection.

In example 34, the subject matter of any one of examples 26 to 33, wherein the off-diagonal dominance includes a diagonal dominance state and an off-diagonal dominance state.

In example 35, the subject matter of any one of examples 26 to 34, wherein the instructions further cause the processor to calculate the off-diagonal dominance of the gram matrix or the spatial covariance matrix.

In example 36, the subject matter of any one of examples 26 to 35, wherein the instructions further cause the processor to determine the class for the condition number of the channel matrix using a neural network-based classifier.

In example 37, the subject matter of example 36, wherein the neural network-based classifier includes a trained neural network configured to receive input data representative of Gershgorin discs of the gram matrix and provide output data representative of the class for the condition number of the channel matrix.

In example 38, the subject matter of example 37, wherein the input data includes a feature vector may include a plurality of diagonal elements of the gram matrix and a corresponding sum of magnitudes of off-diagonal elements of the gram matrix for each diagonal element of the plurality of diagonal elements of the gram matrix.

In example 39, the subject matter of example 36 or 37, wherein the trained neural network is configured to calculate a condition number estimate of the channel matrix; wherein the class for the condition number of the channel matrix is classified based on the condition number estimate.

In example 40, the subject matter of example 37 or 38, wherein the trained neural network is configured to calculate a logarithmic condition number estimate of the channel matrix and classify the class for the condition number of the channel matrix based on the condition number estimate.

In example 41, the subject matter of any one of examples 37 to 40, wherein the input data further includes information representative of one or more singular values of the channel matrix.

In example 42, the subject matter of example 41, wherein the instructions further cause the processor to estimate a maximum singular value associated with the channel matrix; wherein the input data further includes the maximum singular value associated with the channel matrix.

In example 43, the subject matter of example 42, wherein the instructions further cause the processor to estimate the maximum singular of the channel matrix based on a power method for calculation of one or more singular values.

In example 44, the subject matter of example 42, wherein the trained neural network is further configured to estimate a minimum singular value of the channel matrix; wherein the output data is based on the minimum singular value of the channel matrix.

In example 45, the subject matter of example 44, wherein the condition number of the channel matrix is a ratio of the maximum singular value and the minimum singular value.

In example 46, a non-transitory computer-readable medium may include instructions which, if executed by a processor, cause the processor to: estimate an order of magnitude of a condition number of a channel matrix; wherein the channel matrix is representative of a communication channel; determine a degree of an off-diagonal dominance of a gram matrix or a spatial covariance matrix associated with the channel matrix; determine a multiple input multiple output (MIMO) detection algorithm from a plurality of MIMO detection algorithms based on the order of magnitude of the condition number and the degree of the off-diagonal dominance.

In example 47, the subject matter of example 46, wherein the non-transitory computer-readable medium is further configured as described in any one of examples 27 to 45.

In example 48, the subject matter includes a method that may include: determining a class for a condition number of a channel matrix from a plurality of classes; wherein the channel matrix is representative of a communication channel; determining an off-diagonal dominance of a gram matrix or a spatial covariance matrix associated with the communication channel; selecting a multiple input multiple output (MIMO) detection method from a plurality of MIMO detection methods based on the determined class and an off-diagonal dominance.

In example 49, the subject matter of example 48, may further include estimating a bit error gap degree between a minimum mean square estimation (MMSE) estimate of a received radio signal using the communication channel and a maximum likelihood (ML) estimate of the received radio signal.

In example 50, the subject matter of example 48 or example 49, wherein each class of the plurality of classes is representative of a corresponding interval of a magnitude of the condition number.

In example 51, the subject matter of example 50, wherein the plurality of classes includes a first class representative of a first interval of the magnitude of the condition number, a second class representative of a second interval greater than the first interval, and a third class representative of a third interval greater than the second interval.

In example 52, the subject matter of any one of examples 48 to 51, wherein the plurality of MIMO detection methods includes a first MIMO detection method with a first computing overhead, a second MIMO detection method with a second computing overhead greater than the first computing overhead.

In example 53, the subject matter of example 52, may further include selecting one of the first MIMO detection method or the second MIMO detection method according to a calculated metric based on at least the off-diagonal dominance of the gram matrix and a threshold.

In example 54, the subject matter of example 53, may further include causing the processor to select the second MIMO detection method over the first MIMO detection method if the calculated metric is above the threshold.

In example 55, the subject matter of any one of examples 48 to 54, wherein the plurality of MIMO detection methods includes at least one of an MMSE detection, a Zero-Forcing (ZF) detection, a Block Coordinate Descent (BCD) detection, a tree search detection, a maximum a posteriori (MAP) or ML detection, an expectation-maximization (EM) detection.

In example 56, the subject matter of any one of examples 48 to 55, wherein the off-diagonal dominance includes a diagonal dominance state and an off-diagonal dominance state.

In example 57, the subject matter of any one of examples 48 to 56, may further include calculating the off-diagonal dominance of the gram matrix or the spatial covariance matrix.

In example 58, the subject matter of any one of examples 48 to 57, may further include determining the class for the condition number of the channel matrix using a neural network-based classifier.

In example 59, the subject matter of example 58, wherein the neural network-based classifier includes a trained neural network configured to receive input data representative of Gershgorin discs of the gram matrix and provide output data representative of the class for the condition number of the channel matrix.

In example 60, the subject matter of example 59, wherein the input data includes a feature vector may include a plurality of diagonal elements of the gram matrix and a corresponding sum of magnitudes of off-diagonal elements of the gram matrix for each diagonal element of the plurality of diagonal elements of the gram matrix.

In example 61, the subject matter of example 58 or 59, wherein the trained neural network is configured to calculate a condition number estimate of the channel matrix; wherein the class for the condition number of the channel matrix is classified based on the condition number estimate.

In example 62, the subject matter of example 60 or 61, wherein the trained neural network is configured to calculate a logarithmic condition number estimate of the channel matrix and classify the class for the condition number of the channel matrix based on the condition number estimate.

In example 63, the subject matter of any one of examples 59 to 62, wherein the input data further includes information representative of one or more singular values of the channel matrix.

In example 64, the subject matter of example 63, may further include estimating a maximum singular value associated with the channel matrix; wherein the input data further includes the maximum singular value associated with the channel matrix.

In example 65, the subject matter of example 64, may further include estimating the maximum singular of the channel matrix based on a power method for calculation of one or more singular values.

In example 66, the subject matter of example 64, wherein the trained neural network is further configured to estimate a minimum singular value of the channel matrix; wherein the output data is based on the minimum singular value of the channel matrix.

In example 67, the subject matter of example 66, wherein the condition number of the channel matrix is a ratio of the maximum singular value and the minimum singular value.

In example 68, a method may include: estimating an order of magnitude of a condition number of a channel matrix; wherein the channel matrix is representative of a communication channel; determining a degree of an off-diagonal dominance of a gram matrix or a spatial covariance matrix associated with the channel matrix; determining a multiple input multiple output (MIMO) detection algorithm from a plurality of MIMO detection algorithms based on the order of magnitude of the condition number and the degree of the off-diagonal dominance.

In example 69, the subject matter of example 68, wherein the method further includes aspects as described in any one of examples 48 to 67.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUs), Distributed Units (DUs) and Centralized Units (CUs). Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel).

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus comprising a processor configured to:
determine a class for a condition number of a channel matrix from a plurality of classes; wherein the channel matrix is representative of a communication channel;
determine an off-diagonal dominance of a gram matrix or a spatial covariance matrix associated with the communication channel; and
select a multiple input multiple output (MIMO) detection method from a plurality of MIMO detection methods based on the determined class and an off-diagonal dominance.

2. The apparatus of claim 1,
wherein the processor is configured to estimate a bit error gap degree between a minimum mean square estimation (MMSE) estimate of a received radio signal using the communication channel and a maximum likelihood (ML) estimate of the received radio signal.

3. The apparatus of claim 1,
wherein each class of the plurality of classes is representative of a corresponding interval of a magnitude of the condition number.

4. The apparatus of claim 3,
wherein the plurality of classes comprises a first class representative of a first interval of the magnitude of the condition number, a second class representative of a second interval greater than the first interval, and a third class representative of a third interval greater than the second interval.

5. The apparatus of claim 1,
wherein the plurality of MIMO detection methods comprises a first MIMO detection method with a first computing overhead, and a second MIMO detection method with a second computing overhead greater than the first computing overhead.

6. The apparatus of claim 5,
wherein the processor is further configured to select one of the first MIMO detection method or the second MIMO detection method according to a calculated metric based on at least the off-diagonal dominance of the gram matrix and a threshold.

7. The apparatus of claim 6,
wherein the processor is further configured to select the second MIMO detection method over the first MIMO detection method if the calculated metric is above the threshold.

8. The apparatus of claim 1,
wherein the plurality of MIMO detection methods comprises at least one of an MMSE detection, a Zero-Forcing (ZF) detection, a Block Coordinate Descent (BCD) detection, a tree search detection, a maximum a posteriori (MAP) or ML detection, an expectation-maximization (EM) detection.

9. The apparatus of claim 1,
wherein the off-diagonal dominance comprises a diagonal dominance state and an off-diagonal dominance state.

10. The apparatus of claim 1,
wherein the processor is configured to determine the class for the condition number of the channel matrix using a neural network-based classifier.

11. The apparatus of claim 10,
wherein the neural network-based classifier comprises a trained neural network configured to receive input data representative of Gershgorin discs of the gram matrix and provide output data representative of the class for the condition number of the channel matrix.

12. The apparatus of claim 11,
wherein the input data comprises a feature vector comprising a plurality of diagonal elements of the gram matrix and a corresponding sum of magnitudes of off-diagonal elements of the gram matrix for each diagonal element of the plurality of diagonal elements of the gram matrix.

13. The apparatus of claim 12,
wherein the trained neural network is configured to calculate a condition number estimate of the channel matrix; and
wherein the class for the condition number of the channel matrix is classified based on the condition number estimate.

14. The apparatus of claim 12,
wherein the trained neural network is configured to calculate a logarithmic condition number estimate of the channel matrix and classify the class for the condition number of the channel matrix based on the condition number estimate.

15. The apparatus of claim 12,
wherein the input data further comprises information representative of one or more singular values of the channel matrix.

16. The apparatus of claim 1,
wherein the processor is configured to determine a transmit signal based on a receive signal using the MIMO detection method.

17. An apparatus comprising a processor configured to:
estimate an order of magnitude of a condition number of a channel matrix; wherein the channel matrix is representative of a communication channel;
determine a degree of an off-diagonal dominance of a gram matrix or a spatial covariance matrix associated with the channel matrix; and
determine a multiple input multiple output (MIMO) detection algorithm from a plurality of MIMO detection algorithms based on the order of magnitude of the condition number and the degree of the off-diagonal dominance.

18. The apparatus of claim 17,
wherein the processor is configured to determine a transmit signal based on a receive signal using the MIMO detection algorithm.

19. A non-transitory computer-readable medium comprising instructions which, if executed by a processor, cause the processor to:
determine a class for a condition number of a channel matrix from a plurality of classes; wherein the channel matrix is representative of a communication channel;
determine an off-diagonal dominance of a gram matrix or a spatial covariance matrix associated with the communication channel; and
select a multiple input multiple output (MIMO) detection method from a plurality of MIMO detection methods based on the determined class and an off-diagonal dominance.

20. The non-transitory computer-readable medium of claim 19,
wherein the instructions further cause the processor to estimate a bit error gap degree between a minimum mean square estimation (MMSE) estimate of a received radio signal using the communication channel and a maximum likelihood (ML) estimate of the received radio signal.
